(19) United States
(12) Patent Application Publication
(10) Pub. No.: US 2006/0156595 A1
(43) Pub. Date: Jul. 20, 2006

(54) License plate holder with bumper guards

(76) Inventors: Charles J. Kasak, Yonkers, NY (US); Robert Kasak, South Hackensack, NJ (US)

Correspondence Address: Donald R. Heiner, Esq., 71 Mount Vernon Street, Ridgefield Park, NJ, 07660, US

(21) Appl. No.: 11/035,185

(22) Filed: Jan. 14, 2005

(51) Int. Cl. G09F 7/00

(52) U.S. Cl. 40/209

(57) ABSTRACT

A license plate holder, curved or otherwise, for receiving a license plate and wherein the license plate holder further has a pair of bumper guards, preferably of hard rubber or any other hard material to protect the bumpers of a vehicle. In a preferred embodiment the bumper guards are vertical and are disposed on each end of a license plate holder. In another embodiment the bumper guards may be horizontal and placed both at the upper edge and lower edge of the license plate holder and in a third embodiment a license plate holder may have a set of both vertical and horizontal bumper guards incorporated into one license plate holder.

### BACKGROUND OF THE INVENTION

1. Field of the Invention

Applicant's invention relates to a curved motor vehicle license plate holder having disposed therein a pair of bumper guards to protect the bumper of the vehicle itself and any other vehicle's bumper that may be involved in a collision. This license plate holder is somewhat curved to fit most vehicles that have curved bumpers. This license plate holder will be flexible to accommodate the curvature of most vehicle bumpers.

It should be obvious that such a flexible license plate holder as disclosed herein may not be applied to the niche of a curved bumper as an ordinary license plate would be installed. As will be seen later in this application a space in front of curved bumpers having a niche will be directly in back of the mounted curved license plate holder.

Wherein the preferred embodiment of the invention discloses a license plate holder having a pair of vertical bumper guards to protect the vehicle's bumper and any other vehicle's bumper in the event of a collision. These bumper guards may also be placed in a horizontal configuration across the top and bottom of the license plate holder. Further, in yet another embodiment, such a license plate holder may also have a set of vertical and a set of horizontal bumper guards incorporated into one license plate holder.

While these bumper guards are preferably made of a hard rubber material it should be obvious that any other suitable material may be employed.

2. Description of the Prior Art

A search of the prior art has uncovered the following patents: A. S. Thompson, U.S. Pat. No. 2,299,359; L. Fishman, U.S. Pat No. 2,921,395; Lester D294,975; Varga, U.S. Pat. No. 4,903,422; Ching-Hwei, D311,167; and Kuo, U.S. Pat. No. 5,156,455.

No single reference cited above and found during our search discloses all of the features of applicant's invention, although some of these prior art references do disclose some, but not all, of the elements of this invention.

The patent to Thompson, U.S. Pat. No. 2,299,359 discloses a license plate holder 4 secured between two (2) bumper guards 2 as best seen in FIG. 1, and also FIG. 4. Please note the language in column 1 beginning at line 45 “the bumper 1 is of a conventional bar formation and carried vertically disposed guards 2 which project above and below the bumper 1 - - - ”. However, these bumpers are disposed on bumper 1 and not associated with the license plate holder. This appears to be the closest reference uncovered during our search.

The Fishman U.S. Pat. No. 2,921,395 relates to a license plate holder 10′ as seen in FIG. 10 and further having support member 42 and projecting ledge 46 to protect the license plate holder itself. Please see column 2, lines 46-54.

Next is design patent D294,975 to Lester which does disclose a similar “look” but not function as applicant's invention. The single claim of this design patent indicates “the ornamental design for a combined license plate bracket and vehicle back-up signal lights”.

The patent to Varga, U.S. Pat. No. 4,903,422 discloses a license plate frame assembly where the frame member is number 10 in FIGS. 1-3 and wherein there is a forward projected edge around the whole periphery as seen in column 2, lines 38-43.

Design patent D311,167 to Ching-Hwei relates to an automobile license plate holder having projecting top and bottom edges. Again, this is a design patent and therefore simply goes to the way it looks and not to how it functions.

The Baker design patent D471,497S discloses a vehicle license plate frame having a pair of bumpers and vertical rods which appear to extend through the bumpers but without any disclosure of how the bumpers and rods function.

Finally, is the patent to Kuo, U.S. Pat. No. 5,156,455, for a shock absorber for the lamp of an auto license plate holder. We note particularly item 13 and the language contained in column 2, lines 45-51.

It is not seen that any of the above cited references either taken singularly or in combination, discloses the concept of applicant's invention as will be claimed below.

### SUMMARY OF INVENTION

According to the present invention, there is provided a curved license plate holder which can hold to display a standard motor vehicle license plate and which includes a pair of bumper guards to protect the motor vehicle bumper itself and another vehicle's bumper. Such curved holder will fit most motor vehicles having a curved bumper and such holder further has compartments therein to hold two (2) or more bumper guards, preferably of hard rubber, but which can also be made of any other material suitable for the purpose, and, in a preferred embodiment, such bumper compartments and therefore bumpers are disposed vertically on both sides of the license plate holder.

It should also be noted and perhaps should be obvious that these bumper receiving compartments may be horizontal, one at the top edge and one at the bottom edge of the holder, or, in fact, there may be compartments for both horizontal and vertical bumpers incorporated into one license plate holder.

Since there obviously may be differences in the curvature of vehicle bumpers the license plate holder of the instant invention will be flexible in order to accommodate the various curvatures.

It is therefore an object of the present invention to provide a unique license plate holder.

It is another object of the invention to provide such a license plate holder further comprising two (2) compartments for the installation of bumper guards.

It is yet a further object of the invention to provide such a license plate holder wherein the two (2) compartments are vertical and parallel to each other and are spaced apart at opposite ends of the license plate holder.

It is yet a further object of the invention to provide such a license plate holder wherein bumper guards, preferably of hard rubber or other like material, are inserted into each of the vertical compartments to protect the motor vehicle bumpers.

It is yet a further object of the invention to provide such a license plate holder which is curved to fit most motor vehicles having curved front bumpers.

It is still a further object of the invention to provide such a license plate holder wherein a brace is provided in a niche behind the license plate holder to provide a rigid backing for the license plate holder.

It is still a further object of the invention to provide such a license plate holder wherein the aforementioned compartments for holding the bumpers in a vertical position may instead be horizontal across the top and bottom of the license plate holder.

These and further objects, features and advantages of the invention shall become apparent from the following detailed description of a preferred embodiment thereof when taken in conjunction with the drawings, wherein, like reference characters refer to corresponding parts in the several views.

### BRIEF DESCRIPTION OF THE DRAWINGS

FIG. 1 is a perspective of the complete license plate holder, which includes the frame, bumpers, backing, and brace. The license plate is also shown installed in its place.

FIG. 2 is a bottom assembled view of the various parts of the invention, less the license plate itself, and is a bottom view of FIG. 3.

FIG. 3 is a front view of the assembled license plate holder.

FIG. 4 is an exploded bottom view of the license plate holder including the bumper guards and fastening devices and further showing the slot into which the license plate can be inserted.

### DETAILED DESCRIPTION OF THE PREFERRED EMBODIMENT

A license plate holder for mounting to, on, or in a motor vehicle bumper and further having spaced apart vertical compartments for receiving and holding in place bumpers of hard rubber or the like which serve as bumper guards to protect the bumpers of the vehicle itself or any other vehicle involved in a collision will now be described with reference to the drawings.

It should at first be noted that the license plate holder is curved to fit most motor vehicles that have curved bumpers and that such license plate holder further comprises compartments for a pair of hard rubber bumpers with the understanding that the material may be other than hard rubber as long as it serves its' purpose.

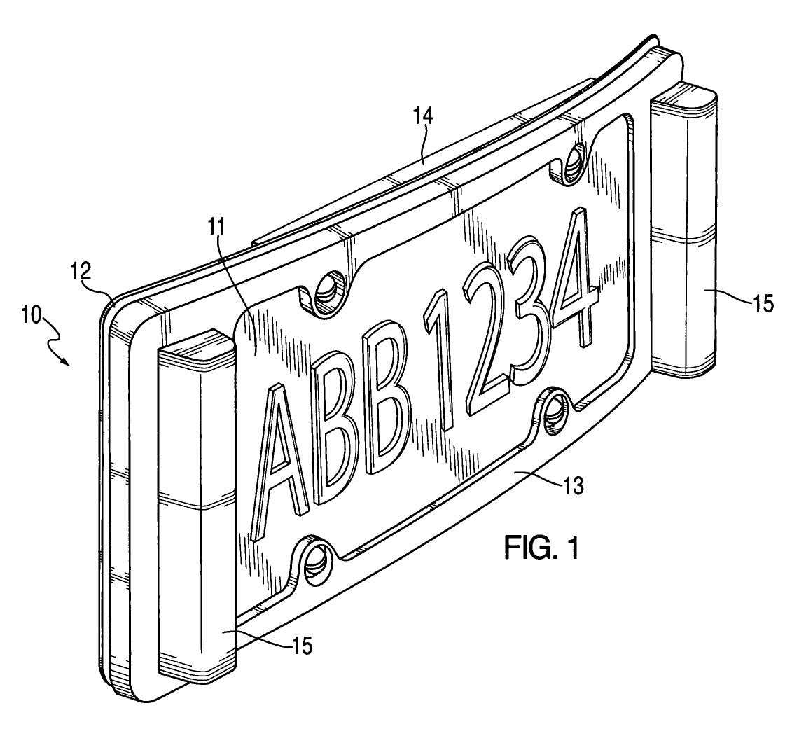

FIG. 1 is a perspective view of the license plate holder showing a license plate in place and wherein the license plate holder is shown generally as number 10.

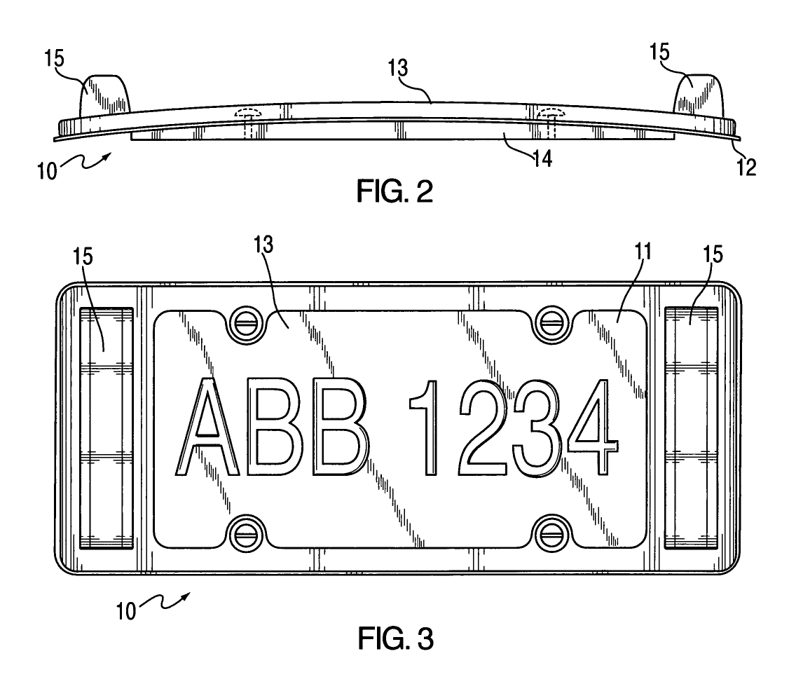

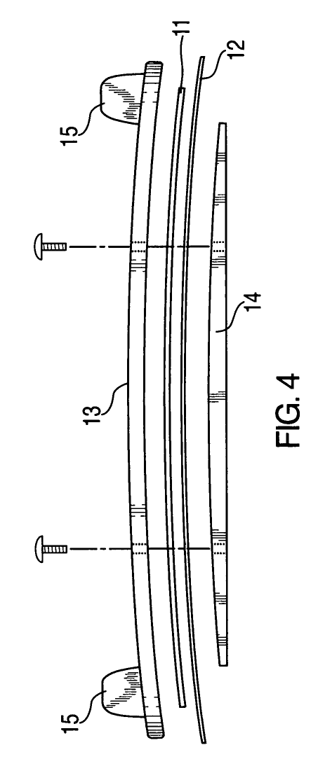

As seen in the several views there are essentially four (4) items comprising the invention. A license plate is conveniently shown in FIGS. 1, 2 and 4 and fastening devices such as threaded screws or the like are also best seen in FIG. 4.

The license plate itself is shown as 11 in FIGS. 1, 3 and 4.

A backing 12, usually curved to conform to the curvature of frame 13 is best seen in FIGS. 1, 2 and 4. The backing 12 may be secured to frame 13 by any well known fastening means. In addition, items 12 and 13 may be manufactured as one piece.

A brace such as 14 best seen in FIGS. 1, 2 and 4 is secured to the vehicle's bumper along with the frame 13 and backing 12 by any well known fastening means that extends through those three (3) items.

When the various parts, items 12, 13 and 15, are permanently assembled such as seen in FIGS. 1, 2 and 3 then license plate 11 can be inserted into the frame through a slot formed at the bottom of the assembled unit.

A plurality of bumper guards such as the two (2) shown as item 15 in all the views serve to protect the motor vehicle bumper itself and protect any other vehicle's bumper that may be involved in a collision. These bumpers 15 are disposed in compartments formed in front plate 13 as probably best seen in FIGS. 1, 2 and 4. These bumpers are preferably formed of a hard rubber material although it should be noted that any other material which will suit the purpose may also be used.

It should be readily obvious that these bumpers may be disposed in horizontal rather than vertical compartments with the horizontal compartments being disposed across the top and across the bottom of the holder.

Still further, vertical and horizontal compartments with these bumpers may also be employed at the same time.

### OPERATION OF THE INVENTION

What has been described is a curved license plate holder having space therein to hold a license plate and will also have two (2) vertical bumper guards.

The license plate itself is installed through a slot at the bottom of the license plate holder and secured in place.

The vertical hard rubber bumpers are then placed in compartments disposed on each end of the license plate holder itself.

Thus, this device serves as a license plate holder and will have bumper guards to protect vehicle bumpers of any vehicles involved in a minor collision.

Although the invention has been described and illustrated with reference to a preferred embodiment, those skilled in the art will appreciate that various changes and modification in the shape, size, composition and arrangement of parts may be resorted to without departing from the spirit of the invention or scope of the subjoined claims.

What is claimed is:

1-5. (canceled)

6. A license plate holder to be attached to a motor vehicle comprising:
(a) a frame;
(b) a backing attachable to said frame;
(c) a brace attached to said frame and said backing by fastening means; wherein said backing and said frame are curved, and;
(d) a plurality of vertical bumpers disposed in compartments formed in said holder to protect lumpers of one or more motor vehicles involved in a collision wherein said plurality of vertical bumpers are of hard rubber.

7. The license plate holder of claim 6 wherein said backing and said frame comprise one piece and wherein a license plate may be inserted into said license plate holder through a slot formed at the bottom of the assembled unit.
